(19) United States
(12) Patent Application Publication
(10) Pub. No.: US 2025/0304792 A1
(43) Pub. Date: Oct. 2, 2025

(54) Road Bitumen Composition (Variants) And Preparation Method Thereof

(71) Applicant: TAIF Joint-Stock Company, Kazan (RU)

(72) Inventors: Albert Kashafovich Shigabutdinov, Kazan (RU); Vladimir Vasilievich PRESNYAKOV, Kazan (RU); Ruslan Albertovich SHIGABUTDINOV, Kazan (RU); Rustem Nazyifovich AKHUNOV, Kazan (RU); Marat Rinatovich IDRISOV, Kazan (RU); Maksim Anatolievich NOVIKOV, Nizhnekamsk (RU); Aleksei Aleksandrovich KHRAMOV, Nizhnekamsk (RU); Andrei Aleksandrovich KONOVNIN, Nizhnekamsk (RU); Artur Semenovich URAZAIKIN, Nizhnekamsk (RU); Viswanathan Anand SUBRAMANIAN, Sugar Land, TX (US)

(21) Appl. No.: 18/618,147

(22) Filed: Mar. 27, 2024

(51) Int. Cl. C08L 95/00; C10C 3/00

(52) U.S. Cl. CPC C08L 95/00; C10C 3/005; C08L 2555/60; C08L 2555/84

(57) ABSTRACT

The invention relates to road bitumen compositions (variants) and a preparation method of a road bitumen composition. According to the first embodiment, the road bitumen composition comprises oxidized bitumen and tar, wherein the oxidized bitumen is a product of oxidation of a mixture of tar and a residual product from hydrocracking of heavy oil residual feedstock. According to the second embodiment, the road bitumen composition comprises the composition according to the first embodiment, a residual product from hydrocracking of heavy oil residual feedstock, a plasticizer, and a styrene-butadiene copolymer. The method of preparing the road bitumen composition comprises mixing tar and a residual product from hydrocracking of heavy oil residual feedstock to obtain a mixture of tar and the residual product from hydrocracking of heavy oil residual feedstock, oxidizing the obtained mixture in an oxidation plant to obtain oxidized bitumen, mixing the obtained oxidized bitumen with tar to produce a first bitumen composition, and mixing the first bitumen composition with the plasticizer, the residual product from hydrocracking of heavy oil residual feedstock, and the styrene-butadiene copolymer to produce a road bitumen composition. The technical result achievable by this invention is the provision of a road bitumen composition in which a residual product from hydrocracking of heavy oil residual feedstock is used and requisite performance characteristics of the road bitumen composition for use in road construction and maintenance are retained, said characteristics including, but not limited to, proper characteristics of change of mass after aging, shear resistance, fatigue resistance, and cold resistance.

### TECHNICAL FIELD

The invention relates to road bitumen compositions, a preparation method of a road bitumen composition, and may be useful in road construction and maintenance. Road bitumen compositions have a number of various applications, including pavement, joint sealing, roadway repair.

### BACKGROUND

The overwhelming majority of road and construction bitumens are produced in the Russian Federation and worldwide by oxidizing a heavy oil residual feedstock, i.e. tar.

However, with inevitable deterioration in quality of oil supplied to oil refining plants and depletion of conventional oil reserves, oil refining plants all over the world start paying more attention to hydrogenation processes that permit processing tar not into bitumen, but into lighter petroleum products such as naphtha, kerosene, diesel oil, thereby increasing the overall economic efficiency of processing oil feedstock. At that, as residues of such hydrogenation processes, which are generally called “hydrocracking” for the purposes of the present invention, high-viscosity and high-boiling concentrates of asphaltenes and high molecular weight resins are generated. Due to their low aggregate stability and the presence of coke and other hydrocarbon-saturated products, such residues are used, as a rule, for producing poor-quality fuel oil. Preparation methods of bitumen, along with compositions involving residual products from hydrocracking of heavy oil residual feedstock, having quality characteristics in conformity with the requirements of regulatory documents were scarcely described owing to lack of studies in residual products of hydrocracking as such. In addition, residual products from hydrocracking of heavy oil residues are highly reactive with respect to oxidative polycondensation processes, which finally affects rapid oxidative aging of bitumens produced from such residues.

Due to the falling cost of residual fuels (fuel oils) caused by large usage of natural gas and high investment costs of deep conversion of tar into target products (delayed coking, hydrocracking), direct measures were recently taken to upgrade vacuum blocks of atmospheric and vacuum distillation units, which resulted in weighting of produced tars involving an increase viscosity RV80 of tar from 70-80 s (see patent RU2476580 published on 20 Aug. 2011) to 100-130 s and even to 200 s, or higher.

At the same time, in addition to the standards GOST 33133-2014 “Public highways. Viscous road petroleum bitumens. Technical requirements” and GOST R 52056-2003 “Road polymer-bitumen binders based of block copolymers of styrene-butadiene-styrene type. Specifications” currently in force, new stricter requirements for bitumen products were developed and took effect under GOST 58400.1-2019 “Public highways. Petroleum-based bitumen binder. Specifications based on operational temperature range” and GOST R 58400.2-2019 “Public highways. Petroleum-based bitumen binders. Specifications based on traffic loads” that involve PG labelling of the bituminous products. A transition from the classification according to conditional indices, which were developed in the beginning of the 20th century and do not reflect rheological properties of a binder (penetration, ring-and-ball temperature, Fraas brittle point) to the classification according to rheological properties having physical sense (developed in the end of 20th century) has occurred. Second, in the SHRP Superpave methodology, which is the basis for newly accepted GOST standards, very much attention is paid to binder aging issues, which is crucial for modern bitumens under the deep oil conversion conditions. It is also very important that the methodology considers ultimate shear strains and load in the initial process step, and stiffness and creeping of a bituminous binder in the end of the oxidation process. This issue was ignored in the previous approach. Third, the methodology permits developing requirements to the binder depending on climate of a road section and traffic conditions thereon. This issue has been hardly taken into account in the preceding approach. These standards have been developed on the grounds of foreign best practices (EU and USA) in studies of binding materials and asphalt concrete under field conditions. High quality of such products can only be reached if the requirements of the above-listed regulatory documents are complied with.

All these factors put forward formidable tasks of not only maintaining but even improving quality of road bitumens.

Patent RU2721118 (C08L95/00, C10C3/04, C10G9/32, C08K3/06, C09D195/00, B01F3/10, B01F5/08, B01F11/02, B01J8/00, B01J19/10, published on 15 May 2020) discloses an invention that is capable of processing residues from the H-Oil hydrogenation process by mixing components of raw materials, which are a mixture of heavy oil-containing residues in thermotropic mesophase, and liquid sulfur, the obtained mixture is heated to a sulfur polymerisation temperature and mixed in a medium without external oxidising agents, wherein to achieve homogeneity of the mixture during mixing, receipt and turbulent flows are formed throughout the whole volume of the material. Drawbacks of this technical solution are:
1) Complexity of the process employing a cavitation plant, which latter will be susceptible to erosive wear in the presence of mechanical impurities and solid particles in the feed stream, which is typical of suspension-bed hydrocracking residues;
2) Liquid sulfur is added to the feed mixture during the preparation of bitumens, which results in formation of considerable amounts of gaseous sulfur oxides and hydrogen sulfide, which produce an adverse effect on the structure and characteristics of bitumen such as change of mass after aging, shear resistance and fatigue resistance.

### SUMMARY OF THE INVENTION

The technical problem solved by the present invention is the provision of a road bitumen composition comprising a residual product from hydrocracking of heavy oil residual feedstock and having requisite performance characteristics for use in road construction and maintenance, which include appropriate characteristics of change of mass after aging, shear resistance, fatigue resistance, and cold resistance.

One of the technical effects of the present invention is the provision of a road bitumen composition in which a residual product from hydrocracking of heavy oil residual feedstock is used and requisite performance characteristics of the road bitumen composition for use in road construction and maintenance are retained, said characteristics including, but not limited to, proper characteristics of change of mass after aging, shear resistance, fatigue resistance, and cold resistance.

Another technical effect of the present invention is the involvement of a residual product from hydrocracking of heavy oil residual feedstock in the production of a road bitumen composition to provide an energetically favourable and/or less resource-demanding process while retaining requisite performance characteristics of the road bitumen composition including, but not limited to, proper characteristics of change of mass after aging, shear resistance, fatigue resistance, and cold resistance.

One more technical effect of the present invention is the provision of a possibility to use a residual product from hydrocracking of heavy oil residual feedstock in a road bitumen composition without adversely affecting its characteristics such as, without limitation, change of mass after aging, shear resistance, fatigue resistance, cold resistance, for use in road construction and maintenance.

Yet another technical effect of the present invention is the reduction of the environmental impact of products from hydrocracking of heavy oil residual feedstock.

One of the technical effects of the present invention is the efficient use of a residual product from hydrocracking of heavy oil residual feedstock in the production of a road bitumen composition.

Said technical problem is solved and said technical results are achieved by road bitumen compositions and a preparation method of a road bitumen composition according to the present invention.

The present invention relates to a road bitumen composition comprising oxidized bitumen and tar, wherein the oxidized bitumen is a product of oxidation of a mixture of tar and a residual product from hydrocracking of heavy oil residual feedstock, wherein:
the amount of the oxidized bitumen is from 60 wt. % to 75 wt. % relative to the total weight of the composition, and the amount of tar is from 25 wt. % to 40 wt. % relative to the total weight of the composition;
the amount of tar in said mixture is from 70 wt. % to 80 wt. % relative to the weight of the mixture, and the amount of the residual product from hydrocracking of heavy oil residual feedstock in said mixture is from 20 wt. % to 30 wt. % relative to the weight of the mixture.

According to an embodiment, the residual product from hydrocracking of heavy oil residual feedstock is the residual product from hydrocracking of tar.

According to an embodiment, the residual product from hydrocracking of heavy oil residual feedstock comprises from 8 wt. % to 30 wt. % of asphaltenes.

According to another embodiment, the residual product from hydrocracking of heavy oil residual feedstock comprises from 25 wt. % to 35 wt. % of saturated hydrocarbons having from 25 to 130 carbon atoms, preferably, from 27 to 127 carbon atoms.

According to an embodiment, the residual product from hydrocracking of heavy oil residual feedstock comprises from 25 wt. % to 35 wt. % of aromatic hydrocarbons having from 25 to 130 carbon atoms, preferably, from 27 to 127 carbon atoms.

According to an embodiment, the composition is intended for use in road construction and/or maintenance.

The present disclosure also relates to a road bitumen composition comprising:
from 50 wt. % to 63 wt. % of the above composition,
from 30 wt. % to 40 wt. % of the residual product from hydrocracking of heavy oil residual feedstock,
from 3 wt. % to 5 wt. % of a plasticizer, and

from 4 wt. % to 5 wt. % of a styrene-butadiene copolymer,

wherein the wt. % is the wt. % relative to the total weight of the composition.

According to an embodiment, the plasticizer is vacuum gas oil. The vacuum gas oil may be vacuum gas oil from vacuum distillation of straight-run fuel oil.

According to an embodiment, the styrene-butadiene copolymer is a linear or branched styrene-butadiene block copolymer. The styrene-butadiene block copolymer may have a molecular weight from 75000 to 85000 Da, wherein the styrene-butadiene block copolymer may have a mass fraction of styrene from 30 wt. % to 35 wt. % and a mass fraction of 1,2-butadiene units from 10 wt. % to 20 wt. %.

The present disclosure also relates to a method of preparing the above road bitumen composition, the method comprising the steps of:
a) mixing tar and the residual product from hydrocracking of heavy oil residual feedstock at the weight ratio from 2 to 4, preferably, from 2.3 to 4, to obtain a mixture of tar and the residual product from hydrocracking of heavy oil residual feedstock;
b) oxidizing the mixture obtained in step a) in an oxidation plant to obtain oxidized bitumen,
c) mixing the oxidized bitumen obtained in step b) with tar at the oxidized bitumen to tar weight ratio from 1.5 to 3 to produce a first bitumen composition,
d) mixing the first bitumen composition with the plasticizer, the residual product from hydrocracking of heavy oil residual feedstock, and the styrene-butadiene copolymer to produce a road bitumen composition.

Embodiments of the proposed invention are displayed and described more thoroughly in the subsequent specification. It is to be understood that the invention allows for other embodiments, and some of their details allow for modification in various apparent aspects without departing from the invention as set forth and described in the subsequent claims. Accordingly, drawings and the specification should be considered, by their nature, as illustrative, not as restrictive.

### BRIEF DESCRIPTION OF THE DRAWINGS

FIG. 1 is a schematic illustration of the block diagram of the method of preparing the road bitumen composition according to the present invention.

### DETAILED DESCRIPTION OF THE INVENTION

In present-day conditions, it is important to be able to use refined products, for example, products from hydrocracking of heavy oil residual feedstock, to obtain commercially required products of appropriate quality. This is equally important from the viewpoint of the energy-efficient processing of heavy oil feedstock, because disposal of products from hydrocracking of heavy oil residual feedstock is energy-consuming and involves economic costs and expenditures in terms of consumption of resources. It may be further noted that not the entire volume of products from hydrocracking of heavy oil residual feedstock can be disposed of, thereby resulting in an inevitable adverse environmental effect.

According to the present disclosure, proposed are road bitumen compositions in which a product from hydrocracking of heavy oil residual feedstock (hereinafter referred to as “hydrocracking residue”) can be used efficiently, without producing remarkable influence on properties of the composition including, but not limited to, change of mass after aging, shear resistance, fatigue resistance, cold resistance. The prepared road bitumen compositions possess all characteristics required by GOST standards. For example, flash point, dynamic viscosity, shear resistance, change of mass after aging, fatigue resistance, cold resistance relate to such properties/characteristics of road bitumen compositions.

The road bitumen composition according to the first embodiment comprises oxidized bitumen and tar, wherein the oxidized bitumen is a product of oxidation of a mixture of tar and a residual product from hydrocracking of heavy oil residual feedstock. According to the present invention, the amount of the oxidized bitumen is from 60 wt. % to 75 wt. % relative to the total weight of the composition, and the amount of tar is from 25 wt. % to 40 wt. % relative to the total weight of the composition. Also, according to the present invention, the amount of tar in the oxidation mixture is from 70 wt. % to 80 wt. % relative to the weight of the mixture, and the amount of the hydrocracking residue in said mixture is from 20 wt. % to 30 wt. % relative to the weight of the mixture.

The present inventors have discovered that use of the hydrocracking residue in the mixture with tar to obtain oxidized bitumen permits utilizing the hydrocracking residue in the road bitumen composition (hereinafter referred to as the “composition”) effectively, without considerable influence on the above-mentioned resulting characteristics. The use of tar in addition to the oxidized bitumen permits adjusting features of the composition to reach the desired characteristics. Said contents of the hydrocracking residue and tar allow using effectively the hydrocracking residue to eliminate considerable influence, in particular an adverse effect, on characteristics of the composition.

The hydrocracking residue may be a product from hydrocracking of heavy oil residue feedstock, such as tar. However, the hydrocracking residue may also be a product from hydrocracking of other heavy oil residual feedstock having high viscosity, for example, fuel oil, heavy gas oil, etc. The present inventors have found that using a residue from hydrocracking of exactly tar is the most reasonable from the viewpoint of characteristics of the resultant composition. However, residues from hydrocracking of other oil residual feedstock may be employed in the present invention as well. The hydrocracking process in generally unlimited and may represent the fixed-bed catalytic process, the fluidized-bed catalytic process, and slurry catalytic process, for example: Veba Combi Cracker, EST, LC-Fining.

Main quality parameters of tar and the residue from its hydrocracking are displayed in Table 1.

TABLE 1

| | | Hydrocracking |
|---|---|---|
| Quality parameters | Tar | residue |
| Density at 15° C. according | 980-1007.4 | 1065-1150 |
| to GOST-3900, kg/m³ | | |
| Sulfur content according to | 2.1-3.3 | 1.7-1.9 |
| GOST R 51947, wt. % | | |
| RV₈₀ (Relative viscosity) | 150-240 | — |
| according to GOST 6258, s | | |
| Carbon residue (Micro Method) | 15-19 | 23-35 |
| according to ASTM D4530, wt. % | | |
| Pour point according to | 33 | 35 and more |
| GOST 20287, ° C. | | |
| Asphaltenes according to | 3-5.5 | 8-28 |
| Total 642, wt. %. | | |
| Mechanical impurities, wt. %. | — | 2-4 |
| Distillation, boiling point ° C.: | | |
| initial boiling point | 401 | 257 |
| 5% | 495 | 322 |
| 10% | | 368 |
| 20% | | 403 |
| 30% | | 439 |
| 40% | | 469 |
| 50% | | 494 |

The hydrocracking residue according to the present invention can have various formulations. The hydrocracking residue may comprise from 8 wt. % to 30 wt. %, preferably from 8 wt. % to 28 wt. % of asphaltenes, from 25 wt. % to 35 wt. %, preferably from 28 wt. % to 32 wt. % of saturated hydrocarbons having from 25 to 130 carbon atoms, preferably from 27 to 127 carbon atoms, from 25 wt. % to 35 wt. %, preferably from 29 wt. % to 33 wt. % of aromatic hydrocarbons having from 25 to 130 carbon atoms, preferably from 27 to 127 carbon atoms. The present inventors have discovered that use of a hydrocracking residue comprising the above-stated amount of asphaltenes produces additional influence on provision of the possibility to produce compositions with proper characteristics associated with resistance to aging, for example, oxidative aging, thermal aging, and a combination thereof, and with change of mass after aging. Said content of saturated hydrocarbons and aromatic hydrocarbons additionally influences the possibility to use effectively the hydrocracking residue in compositions without adversely affecting performance/characteristics of compositions.

The road bitumen composition according to the second embodiment includes the composition according to the first embodiment, the hydrocracking residue, a plasticizer, and a styrene-butadiene copolymer. The road bitumen composition according to the second embodiment may be a polymer bitumen binder for use in road construction and/or maintenance.

Additionally, inclusion of the hydrocracking residue in an amount from 30 wt. % to 40 wt. % relative to the total weight of the composition permits using effectively the hydrocracking residue to provide a resource-demanding and energetically favourable process with a reduced impact on environment. At that, the inclusion of the hydrocracking residue does not have an adverse effect on characteristics of the composition.

The present inventors have discovered that use of a styrene-butadiene copolymer in the composition, especially the styrene-butadiene copolymer as described below and in an amount from 4 wt. % to 5 wt. % relative to the total weight of the composition, allows for effective use of the hydrocracking residue. Without wishing to be bound by theory, the present inventors suppose that the styrene-butadiene copolymers incorporated into the composition form their three-dimensional structural network due to mutual interaction of polymer molecules or form “conjugated” structures with functional groups of asphaltenes thus creating chemical bonds and thereby stabilizing asphaltenes by preventing their coagulation and sedimentation. It permits involving a larger amount of the hydrocracking residue that has a greater asphaltene content compared to conventional tar-derived bitumens.

The styrene-butadiene copolymer employed in the present invention may be a linear or branched styrene-butadiene block copolymer. The copolymer, particularly the styrene-butadiene block copolymer, may have a molecular weight from 75000 to 85000 Da, a mass fraction of styrene from 30 wt. % to 35 wt. %, and a mass fraction of 1,2-butadiene units from 10 wt. % to 20 wt. %. Use of such a styrene-butadiene copolymer is preferable from the viewpoint of the aforementioned advantages from employing the copolymer in the composition.

The composition according to the present invention may include a plasticizer in an amount from 3 wt. % to 5 wt. % relative to the total weight of the composition, wherein the plasticizer is vacuum gas oil, particularly vacuum gas oil from vacuum distillation of straight-run fuel oil. The present inventors further point out that any petroleum product distilling at a boiling point in the range of 350° C.-510° C. and comprising predominantly aliphatic hydrocarbons having a carbon number from 20 to 50 can be used as a plasticizer. Use of such a plasticizer, especially in the aforementioned amount, permits adjusting properties/characteristics of the composition. In particular, the plasticizer may be useful for improvement of dispersion of the copolymer, and for attachment of low-temperature properties to the composition.

The method of preparing the road bitumen composition according to the second embodiment comprises the steps of:
a) mixing tar and the residual product from hydrocracking of heavy oil residual feedstock at the tar to residual product weight ratio from 2 to 4, preferably, from 2.3 to 4, to obtain a mixture of tar and the residual product from hydrocracking of heavy oil residual feedstock;
b) oxidizing the mixture obtained in step a) in an oxidation plant to obtain oxidized bitumen,
c) mixing the oxidized bitumen obtained in step b) with tar at the oxidized bitumen to tar weight ratio from 1.5 to 3 to produce a first bitumen composition, particularly, the composition according to the first embodiment,
d) mixing the first bitumen composition with the plasticizer, the residual product from hydrocracking of heavy oil residual feedstock, and the styrene-butadiene copolymer to produce a road bitumen composition.

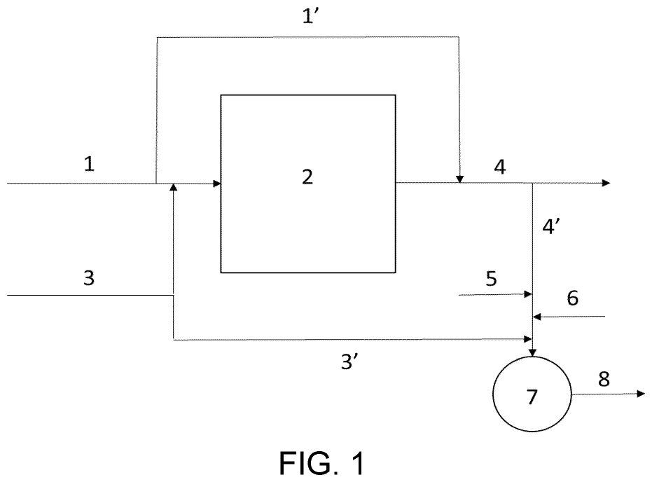

The method of preparing a road bitumen composition according to the present disclosure is displayed schematically in the FIG. 1, with all explicit apparent aspects reflected in the FIG. 1 being included in the present specification. According to the FIG. 1, first, the oxidized bitumen is produced through the “overoxidation-dilution” technology. A mixture consisting of a hydrocracking residue and tar is subjected to oxidation in an oxidation column. On the whole, the tar may be any tar obtained after oil processing, for example, after oil processing that includes, e.g., electrical desalting, dehydration, atmospheric distillation and vacuum distillation of oil. The oxidation column may represent substantially any column utilized for oxidizing bitumen. In general, the oxidation column is a cylindrical vessel adapted for air-blowing raw tar in the vertical or horizontal direction. Such columns are well known in the art, for instance, patent U.S. Pat. No. 3,935,093 A discloses a similar column. The oxidation is performed to a softening point ring and ball between 70° and 75° C. The oxidized bitumen is then diluted with initial tar to a softening ring-and-ball point of 48-49° C. to produce a first bitumen composition. The softening point of the oxidized bitumen may be higher than the claimed ring-and-ball softening point of 70-75° C., in this case the tar consumption for dilution will be higher. Thereafter, the process is either stopped and this first bitumen composition is conveyed to storage or the process is continued to obtain the road bitumen composition according to the second embodiment. If the process is continued, the first bitumen composition is mixed with the hydrocracking residue and a plasticizer, e.g. vacuum gas oil, and fed to additional agitation, e.g. in a mill, e.g. in a colloid mill. Then the styrene-butadiene copolymer is supplied to the mill. Mixing is performed to disperse the polymer in the structure of the mixture/composition. Further, the resulting flow/mixture/composition is directed to a maturation step, in which, as the present inventors suppose, the three-dimensional network of the polymer is formed within 6-8 hours.

In particular, the FIG. 1 illustrates schematically the method of preparing a road bitumen composition according to the present invention. Line 1 is intended for supplying/conveying tar and a mixture of tar with the hydrocarbon residue to an oxidation plant 2 to produce oxidized bitumen. Line 3 is intended for supplying/conveying the hydrocracking residue to the oxidation plant 2 via line 1 to produce oxidized bitumen. In general, the lines 1, 1′, 3, 3′, 4, 4′, 5, 6, 8 shown in the FIG. 1 may encompass corresponding transmission pipelines or any other conveying/supplying means for conveying/supplying materials, including tar, a mixture of tar and the hydrocracking residue, oxidized bitumen, a plasticizer (e.g. vacuum gas oil), a styrene-butadiene copolymer, the first road bitumen composition, which are known to those skilled in the art. The lines 1, 1′, 3, 3′, 4, 4′, 5, 6, 8 shown in the FIG. 1 may also encompass corresponding mixers or any other mixing means, which are known to those skilled in the art, for mixing the aforementioned components. In the line 1, the tar and the hydrocracking residue are subjected to mixing and/or compounding. The tar is fed via the line 1, the hydrocracking residue is supplied via the line 3 to the line 1, where, in the line 1, the tar and the hydrocracking residue are subjected to mixing. The tar and the hydrocracking residue may also be mixed appropriately in the oxidation plant 2. The tar and the hydrocracking residue may be pre-mixed in a corresponding mixing device/means to be supplied to the oxidation plant 2, such as an oxidation column. In the oxidation plant 2, the mixture of tar and hydrocracking residue from the line 1 is subjected to oxidation to produce oxidized bitumen. The oxidized bitumen from the plant 2 is then discharged via line 4. The tar is supplied to the line 4 via line 1′ as a diluent so as to dilute the oxidized bitumen from the plant 2. The tar and the oxidized bitumen are subjected to mixing in the line 4 to obtain the first composition or the road bitumen composition according to the first embodiment. The obtained composition may be conveyed via the line 4 to storage for further use. The obtained composition may be supplied via line 4′ to a mixing device 7, such as e.g. a mill, particularly a colloid mill. The plasticizer and the styrene-butadiene copolymer are supplied to the line 4′ from lines 5 and 6, respectively, for subsequent supply of the resulting mixture (for example, a second composition) to the mixing device 7. The plasticizer and the styrene-butadiene copolymer may be supplied to the mixing device 7 directly, too. The first composition, the plasticizer, and the styrene-butadiene copolymer are subjected to mixing and/or compounding in the mixing device 7 to produce the road bitumen composition according to the second embodiment or a polymer-bitumen binder composition. The obtained composition is then directed via line 8 to storage and/or maturation.

The present inventors have discovered that the use of the ratios of components set out in steps a) and c) allows utilizing the hydrocracking residue effectively to produce compositions without an adverse effect on characteristics/properties of the composition.

### EXAMPLES

The hydrocracking residue employed in the examples was a residue from hydrocracking tar having the formulation as stated in Table 2.

TABLE 2

| | Hydrocracking residue, |
|---|---|
| SARA content | wt. %. |
| Saturated hydrocarbons (SH) | 28-32 |
| Aromatic hydrocarbons (AH) | 29-33 |
| Resins (R) | 18-21 |
| Asphaltenes (A) | 8-28 |
| Carbenes | 0.5-2 |
| Carboids | 0.1-1.0 |

A series of industrial tests have been conducted that employed weighted high-viscosity tars produced on the ELOU-AVT-7 commercial plant, and a residue from hydrocracking of tar. ELOU-AVT-7 is the petroleum processing plant in which electrical desalting, dehydration, atmospheric distillation and vacuum distillation of oil are performed.

Oxidation was conducted according to the “overoxidation-dilution” technology on the Buturox commercial plant, which is an oxidation column. However, the oxidation process can be performed according to any other technology, for example, in hollow oxidizing stills, in a thin film. A mixture of tar and a residue from its hydrocracking was used as the raw material for oxidation, wherein the following working conditions of the oxidation column were maintained:
Oxidation temperature, ° C.: 242-255
Reactor residence time, hours: 5-6.6
Air consumption, kg/h: 1000-2200
Reactor pressure, MPa: 0.12-0.15

The raw material for oxidation was a mixture having the following composition, wt. %:
Tar 70.0-80.0
Residue from hydrocracking of tar 20.0-30.0

Immediately after the reactor, the overoxidized mixture of tar and residue from hydrocracking of tar was diluted with tar supplied to the oxidized mixture at a rate from 20 to 40%. The compounded tar was then directed to storage tanks for storage at a temperature of 150-180° C. As soon as a storage tank is filled, a bitumen sample is taken for further analysis.

The average content of the residue from hydrocracking of heavy oil residual feedstock in the mixture of tar and the residual product from hydrocracking of heavy oil residual feedstock is 12-24 wt. %, and a styrene-butadiene block copolymer was introduced into bitumen product compositions in order to increase said content. Moreover, a plasticizer was used to improve dispersion of the polymer and to impart low-temperature properties to the bitumen composition. For the purposes of this invention, vacuum gas oil obtained by vacuum distillation of straight-run fuel oil from supplied petroleum was used as the plasticizer.

### Example 1

A mixture consisting of 20 wt. % of a residue from hydrocracking of tar and 80 wt. % of tar was used as the feedstock for oxidation.

The oxidation was performed at 242° C., at a pressure of 0.12-0.13 MPa, and air consumption of 1050-1100 kg/h till the softening point of the product of 60-65° C. is reached. After the reactor, 25-30 wt. % of tar based on the total weight of the composition were added to the oxidized bitumen. Characteristics of the obtained composition are set out in Table 3. The composition fully meets the requirements for PG64-28 grade according to GOST 58400.1-2019.

### Example 2

A mixture consisting of 20 wt. % of a residue from hydrocracking of tar and 80 wt. % of tar was used as the feedstock for oxidation.

The oxidation was performed at 245° C., at a pressure of 0.12-0.13 MPa, and air consumption of 1150-1200 kg/h till the softening point of the product of 55-60° C. is reached. After the reactor, 25-30 wt. % of tar based on the total weight of the composition were added to the oxidized bitumen. Characteristics of the obtained composition are set out in Table 3. The composition fully meets the requirements for PG64-28 grade according to GOST 58400.1-2019.

### Example 3

A mixture consisting of 30 wt. % of a residue from hydrocracking of tar and 70 wt. % of tar was used as the feedstock for oxidation.

The oxidation was performed at 255° C., at a pressure of 0.14-0.15 MPa, and air consumption of 2050-2200 kg/h till the softening point of the product of 70-75° C. is reached. After the reactor, 40 wt. % of tar based on the total weight of the composition were added to the oxidized bitumen. Characteristics of the obtained composition are set out in Table 3. The composition fully meets the requirements for PG64-28 grade according to GOST 58400.1-2019.

### Example 4

The bitumen composition was produced by dispersing a mixture having the following formulation, wt. %:

| | |
|---|---|
| The bitumen composition from Example 1 | 52.6 |
| Residue from hydrocracking of tar | 40.0 |
| Plasticizer | 3.0 |
| Linear styrene-butadiene block copolymer | 4.4. |

The dispersion was conducted at a temperature of 180-185° C. on a commercial colloid mill, after which the mixture was supplied to maturation tanks. After 6 hours, samples were taken and then analysed. Characteristics of the obtained composition are set out in Table 3. The composition fully meets the requirements for PG64-34 grade according to GOST 58400.1-2019.

### Example 5

The bitumen composition was produced by dispersing a mixture having the following formulation, wt. %:

| | |
|---|---|
| The bitumen composition from Example 1 | 62.4 |
| Residue from hydrocracking of tar | 30.0 |
| Plasticizer | 3.0 |
| Branched styrene-butadiene block copolymer | 4.6. |

The dispersion was conducted at a temperature of 180-185° C. on a commercial colloid mill, after which the mixture was supplied to maturation tanks. After 6 hours, samples were taken and then analysed. Characteristics of the obtained composition are set out in Table 3. The composition fully meets the requirements for PG70-34 grade according to GOST 58400.1-2019 and PG58(E)-28 grade according to GOST 58400.2-2019.

### Example 6

The bitumen composition was produced by dispersing a mixture having the following formulation, wt. %:

| | |
|---|---|
| The bitumen composition from Example 1 | 50.7 |
| Residue from hydrocracking of tar | 40.0 |
| Plasticizer | 5.0 |
| Linear styrene-butadiene block copolymer | 4.3. |

The dispersion was conducted at a temperature of 180-185° C. on a commercial colloid mill, after which the mixture was supplied to maturation tanks. After 6 hours, samples were taken and then analysed. Characteristics of the obtained composition are set out in Table 3. The composition fully meets the requirements for PG64-34 grade according to GOST 58400.1-2019.

### Example 7

The bitumen composition was produced by dispersing a mixture having the following formulation, wt. %:

| | |
|---|---|
| The bitumen composition from Example 1 | 58.0 |
| Residue from hydrocracking of tar | 35.0 |
| Plasticizer | 3.0 |
| Branched styrene-butadiene block copolymer | 4.0. |

The dispersion was conducted at a temperature of 180-185° C. on a commercial colloid mill, after which the mixture was supplied to maturation tanks. After 6 hours, samples were taken and then analysed. Characteristics of the obtained composition are set out in Table 3. The composition fully meets the requirements for PG64-28 grade according to GOST 58400.1-2019.

TABLE 3

| | | | Requirements | | | | | | | |
|---|---|---|---|---|---|---|---|---|---|---|
| | | | of GOST | | | | | | | |
| | | | R58400.1- | Examples | | | | | | |
| No. | Index | Units | 2019 | 1 | 2 | 3 | 4 | 5 | 6 | 7 |

Quality indices of the initial bitumen binder

| 1. | Flash | ° C. | Above 230 | | 287 | 288 | 282 | 285 | 293 | 280 | 290 |
|---|---|---|---|---|---|---|---|---|---|---|---|
| | point | | | | | | | | | | |
| 2. | Dynamic | Pa*s | At 135° C. | Less | 1.171 | 1.251 | 0.536 | 1.133 | 1.357 | 1.100 | 1.25 |
| | viscosity | | | than 3.0 | | | | | | | |
| 3. | Shear | kPa | At 58° C. | At | 2.530 | 3.136 | 4.020 | 2.651 | 3.375 | 2.541 | 2.951 |
| | resistance | | At 64° C. | least 1.0 | 1.175 | 1.489 | 1.920 | 1.570 | 2.001 | 1.460 | 1.67 |
| | at 10 | | At 70° C. | | 0.559 | 0.734 | 0.942 | 0.656 | 1.126 | 0.71 | 0.91 |
| | rads/s | | | | | | | | | | |

Quality indices of the RTFOT aged bitumen binder

| 4. | Change of | % | ±1.0 | | 0.5 | 0.5 | 0.2 | 0.7 | 0.6 | 0.8 | 0.6 |
|---|---|---|---|---|---|---|---|---|---|---|---|
| | mass after | | | | | | | | | | |
| | aging | | | | | | | | | | |
| 5. | Shear | kPa | At 64° C. | At | 2.245 | 2.539 | 2.111 | 2.349 | — | 2.31 | — |
| | resistance | | At 70° C. | least 2.2 | 1.104 | 1.654 | 4.453 | 1.296 | 2.719 | 2.0 | 2.4 |
| | at 10 | | | | | | | | | | |
| | rads/s | | | | | | | | | | |

Quality indices of the PAV aged bitumen binder at 100° C.

| | | | | | | | | | | | |
|---|---|---|---|---|---|---|---|---|---|---|---|
| 6. | Fatigue | kPa | At 22° C. | Less | 955 | 749 | 2238 | 346 | 1154 | 331 | 1050 |
| | resistance | | At 19° C. | than | 1824 | 1703 | 3218 | 523 | 2237 | 515 | 2125 |
| | at 10 rads/s | | | 5000 | | | | | | | |
| 7. | Cold | MPa | Πp [symbol] | Less | 170 | 358 | 438 | 19 | 191 | 62 | 181 |
| | resistance: | | −18° C. | than | 0.367 | 0.196 | 0.206 | 0.469 | 0.384 | 0.522 | 0.321 |
| | stiffness S | | At −24° C. | 300 At | 339 | 132 | 218 | 10 | 254 | 56 | 220 |
| | parameter m | | | least 0.3 | 0.209 | 0.344 | 0.253 | 0.447 | 0.311 | 0.464 | 0.287 |

1. A road bitumen composition comprising oxidized bitumen and tar, wherein the oxidized bitumen is a product of oxidation of a mixture of tar and a residual product from hydrocracking of heavy oil residual feedstock, wherein:
the amount of the oxidized bitumen is from 60 wt. % to 75 wt. % relative to the total weight of the composition, and the amount of tar is from 25 wt. % to 40 wt. % relative to the total weight of the composition;
the amount of tar in said mixture is from 70 wt. % to 80 wt. % relative to the weight of the mixture, and the amount of the residual product from hydrocracking of heavy oil residual feedstock in said mixture is from 20 wt. % to 30 wt. % relative to the weight of the mixture.

2. The composition according to claim 1, wherein the residual product from hydrocracking of heavy oil residual feedstock is the residual product from hydrocracking of tar.

3. The composition according to claim 1, wherein the residual product from hydrocracking of heavy oil residual feedstock comprises from 8 wt. % to 30 wt. % of asphaltenes.

4. The composition according to claim 1, wherein the residual product from hydrocracking of heavy oil residual feedstock comprises from 25 wt. % to 35 wt. % of saturated hydrocarbons having from 25 to 130 carbon atoms, preferably, from 27 to 127 carbon atoms.

5. The composition according to claim 1, wherein the residual product from hydrocracking of heavy oil residual feedstock comprises from 25 wt. % to 35 wt. % of aromatic hydrocarbons having from 25 to 130 carbon atoms, preferably, from 27 to 127 carbon atoms.

6. The composition according to claim 1, wherein the composition is intended for use in road construction and/or maintenance.

7. A road bitumen composition comprising:
from 50 wt. % to 63 wt. % of the composition according to claim 1,
from 30 wt. % to 40 wt. % of a residual product from hydrocracking of heavy oil residual feedstock,
from 3 wt. % to 5 wt. % of a plasticizer, and
from 4 wt. % to 5 wt. % of a styrene-butadiene copolymer,
wherein the wt. % is the wt. % relative to the total weight of the composition.

8. The composition according to claim 7, wherein the plasticizer is vacuum gas oil.

9. The composition according to claim 8, wherein the vacuum gas oil is the vacuum gas oil from vacuum distillation of straight-run fuel oil.

10. The composition according to claim 7, wherein the styrene-butadiene copolymer is a linear or branched styrene-butadiene block copolymer.

11. The composition according to claim 10, wherein the styrene-butadiene block copolymer has a molecular weight from 75000 to 85000 Da, wherein the styrene-butadiene block copolymer may have a mass fraction of styrene from 30 wt. % to 35 wt. % and a mass fraction of 1,2-butadiene units from 10 wt. % to 20 wt. %.

12. A method of preparing the road bitumen composition according to claim 7, the method comprising the steps of:
a) mixing tar and a residual product from hydrocracking of heavy oil residual feedstock at the weight ratio of tar to the residual product from hydrocracking of heavy oil residual feedstock from 2 to 4, to obtain a mixture of tar and the residual product from hydrocracking of heavy oil residual feedstock;
b) oxidizing the mixture obtained in step a) in an oxidation plant to obtain oxidized bitumen,
c) mixing the oxidized bitumen obtained in step b) with tar at the oxidized bitumen to tar weight ratio from 1.5 to 3 to produce a first bitumen composition,
d) mixing the first bitumen composition with the plasticizer, the residual product from hydrocracking of heavy oil residual feedstock, and the styrene-butadiene copolymer to produce a road bitumen composition.
